(19) United States
(12) Patent Application Publication
(10) Pub. No.: US 2009/0089019 A1
(43) Pub. Date: Apr. 2, 2009

(54) APPARATUS AND METHODS FOR GENERATING A POINT REPRESENTATION OF A STRUCTURE

(76) Inventors: Rainer Dittmann, Seattle, WA (US); Scott D. Hartshorn, Everett, WA (US); Donald Thomas Powell, Everett, WA (US); Dean Parham, Issaquah, WA (US)

Correspondence Address: HARNESS DICKEY & PIERCE, PLC, P.O. BOX 828, BLOOMFIELD HILLS, MI, 48303, US

(21) Appl. No.: 11/865,460

(22) Filed: Oct. 1, 2007

(51) Int. Cl. G06F 17/50; G06G 7/64; G06G 7/72

(52) U.S. Cl. 703/1

(57) ABSTRACT

A computer-performed method of modeling a physical structure. A plurality of geometric parameters specific to a type of the structure are applied to aerodynamic surface data in accordance with rules predefined for the structure type to geometrically describe a plurality of structural features. Based on the geometric describing, a plurality of points representing the structure are obtained. The points are used to model the structure.

### FIELD

The present disclosure relates generally to computer-assisted structural design and more particularly (but not exclusively) to configuring data for input to finite element modeling.

### BACKGROUND

The statements in this section merely provide background information related to the present disclosure and may not constitute prior art.

Finite element analysis (FEA) can be a powerful tool in the designing of aircraft and other complex structures. A three-dimensional computer model of a structure typically is defined using a system of points, also called nodes, and a mesh that can be associated with various structural and/or material properties. The model can be subjected to static and/or dynamic testing.

### SUMMARY

The present disclosure, in one implementation, is directed to a computer-performed method of modeling a physical structure. A plurality of geometric parameters specific to a type of the structure are applied to aerodynamic surface data in accordance with rules predefined for the structure type to geometrically describe a plurality of structural features. Based on the geometric describing, a plurality of points representing the structure are obtained. The points are used to model the structure.

In another implementation, the disclosure is directed to a system for automatically generating a point representation of a structure. The system includes a processor and memory configured to apply, in accordance with rules predefined for a type of the structure, a plurality of geometric parameters to an aerodynamic surface defined for the structure. The processor and memory are also configured to use one or more results of the applying to geometrically describe a plurality of structural features, and to use the features to define a plurality of points representing the structure.

In yet another implementation, the disclosure is directed to a computer-readable medium for automatically generating a point representation of a physical structure. The medium includes instructions executable by a computer for using a surface definition of the structure to obtain parameters geometrically descriptive of at least part of the structure, using the parameters to define at least some features of the structure, and, based on the at least some features, defining a plurality of points representing the structure.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a system for generating a point representation of a structure in accordance with one implementation of the disclosure;

FIG. 2 is a flow diagram of a method of modeling a structure in accordance with one implementation of the disclosure;

FIG. 3 is a flow diagram of a method of modeling a structure in accordance with one implementation of the disclosure;

FIG. 4 is a flow diagram of a method of modeling a nacelle inlet in accordance with one implementation of the disclosure;

FIG. 5A is a screen shot of a surface for a nacelle in accordance with one implementation of the disclosure; and

FIGS. 5B-5E are screen shots of a profile used to generate input points for modeling an inlet in accordance with one implementation of the disclosure.

### DETAILED DESCRIPTION

The following description is merely exemplary in nature and is not intended to limit the present disclosure, application, or uses. While various embodiments are described in the present disclosure, those skilled in the art will recognize modifications or variations which might be made without departing from the present disclosure. The following examples illustrate the various embodiments and are not intended to limit the present disclosure. Therefore, the description and claims should be interpreted liberally with only such limitation as is necessary in view of the pertinent prior art. For example, although various implementations are described with reference to aircraft parts, implementations are possible in connection with other structures, including but not limited to stationary structures, at least partially movable structures, and other mobile structures such as automobiles and other motor vehicles, ships and other vessels, etc.

In various implementations of the disclosure, a method is provided for working with aerodynamic surfaces and using knowledge-based rules to automatically define the structural geometry of an aircraft part. Although existing knowledge-based tools can be used to create a finite element model of an aircraft part quickly once the structural geometry of a part is defined, the tools typically do not work from surface data. In order to use existing knowledge-based tools, a person must define the structural geometry by hand in order to create the input for the knowledge-based tools. The intervention of a person in order to define the structure of a part can significantly slow down a process of creating a finite element model. Additionally, each part must have its structural geometry defined separately, and each finite element model must be generated one at a time.

In some implementations of the disclosure, a process is provided whereby aerodynamic surfaces for an aircraft part may be parametrically analyzed to define a structure of the part. Typical construction geometry composed, e.g., of lines and surfaces, can be used to obtain a structural definition of a part in the form of points. The points may be used as input, for example, to a finite modeling tool to obtain a finite element model. A system and method in which structural points are used as input for generating finite element models is described in Powell et al., U.S. patent application Ser. No. 09/952,026, filed Sep. 12, 2001, the disclosure of which is incorporated herein by reference in its entirety. In the system and method of Powell et al., points defining geometrical structure of a component are input, together with input defining materials and properties of the component, to generate a finite element model of the component.

In various methods in accordance with the disclosure, typical construction geometry, e.g., for an aircraft part can be used as a reference for extracting points through the use, e.g., of intersections, ratios along lines, and edges of the geometry. Various methods are provided for parsing and organizing geometry of a part so that points can be rapidly extracted. Various implementations make it possible to rapidly convert aerodynamic data into structural geometry without human intervention.

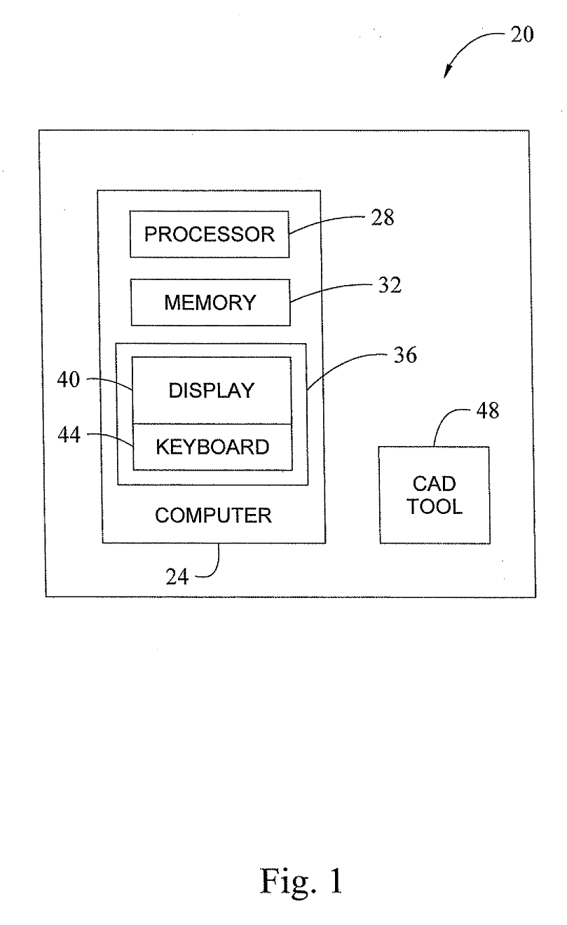

Various methods in accordance with the disclosure may be performed using a system indicated generally in FIG. 1 by reference number 20. The system 20 includes a computer 24 having a processor 28, a memory 32, and a user interface 36 having a display 40 and a keyboard 44. The computer 24 may be programmed with instructions for performing one or more methods in accordance with the disclosure. The system 20 also may include a computer-assisted design (CAD) tool 48. One such tool is Catia, available from Dassault Systèmes, www.3ds.com, although other or additional CAD tools may be used. Those knowledgeable in the art will appreciate that many different configurations of one or more computers, microcomputers, processors, microprocessors, memory, input/out devices, user tools, user interfaces, etc., could be used in various implementations of the disclosure.

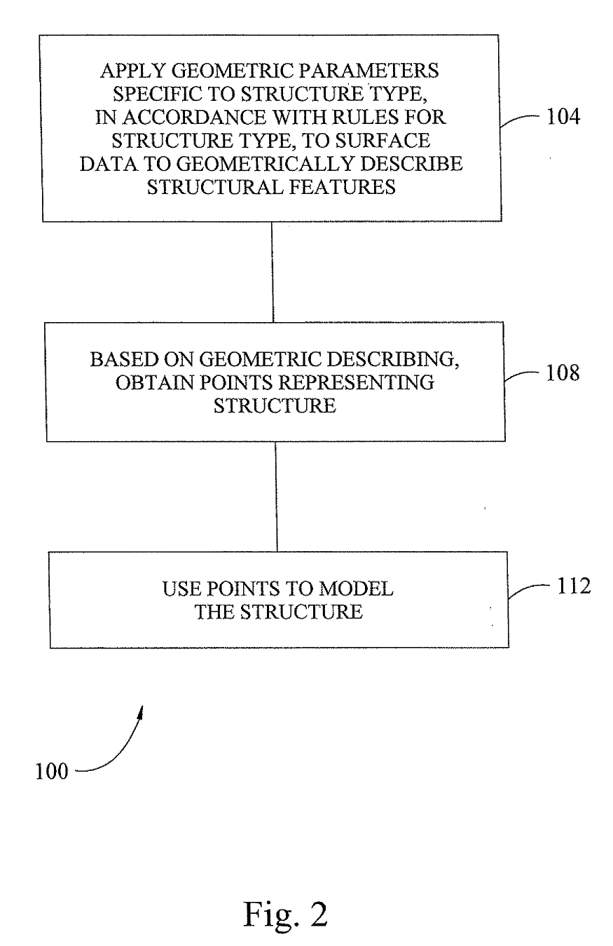

A computer-performed method of modeling a physical structure in accordance with one implementation of the disclosure is indicated generally in FIG. 2 by reference number 100. In step 104 a plurality of geometric parameters are applied to aerodynamic surface data. The parameters are specific to a type of structure to be modeled. The geometric parameters are applied in accordance with rules predefined for the structure type, to geometrically describe a plurality of structural features. In step 108, based on the geometric describing, a plurality of points representing the structure are obtained. In step 112, the points are used to model the structure.

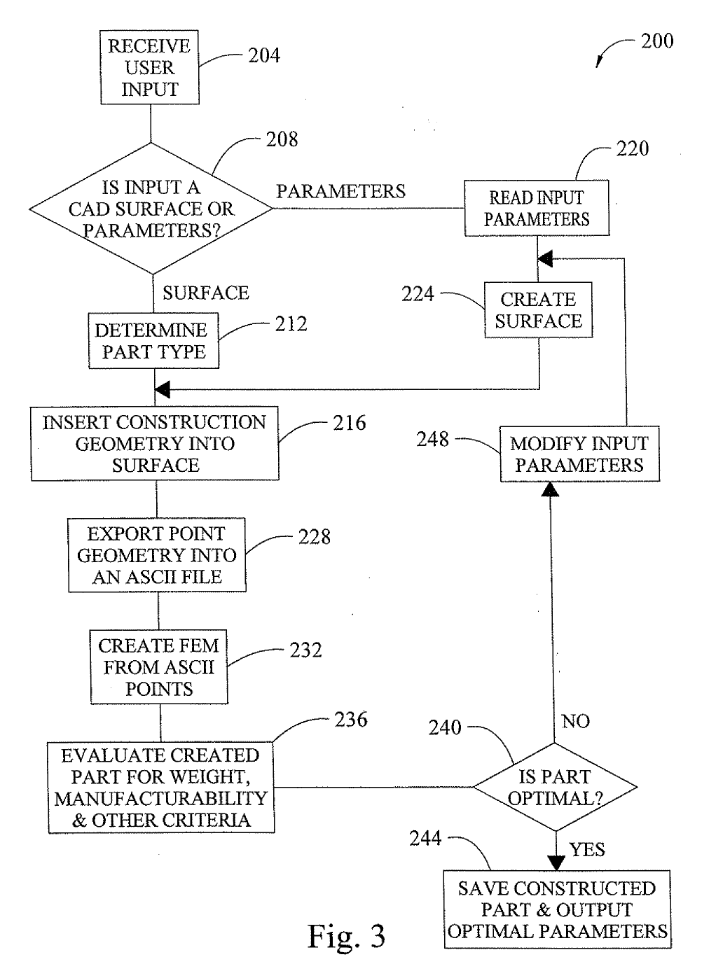

One implementation of a method of modeling a physical structure is indicated generally in FIG. 3 by reference number 200. In the present exemplary implementation, the physical structure to be modeled is an inlet of an aircraft engine nacelle. It should be noted generally that implementations are contemplated with respect to various types of structures, including structures that may include numerous parts or components. A user of, e.g., the system 20 (shown in FIG. 1) may input one or more parameters to the CAD tool 48 to represent a part by aerodynamic surface data. As a simple example, a user might provide a length and a radius as input parameters to the CAD tool 48 to obtain a definition of a cylindrical surface. CAD surface representations for an aircraft part could, e.g., be stored in the computer 24 and subsequently retrieved for use in the system 20 as further described below.

Referring again to FIG. 3, in step 204 the system 20 receives user input. In step 208 it is determined whether the input is (a) a CAD file including one or more surfaces representing a specific part or (b) input parameters supplied by the user for a part designated by the user. If the input is a CAD file, then in step 212 the type of the part (in the present example, an aircraft engine nacelle inlet) is identified and input, along with the surface data for the part, to step 216. If the input is user-supplied parameters, then in step 220 the user input parameters are read. In step 224 an aerodynamic surface is obtained from the input parameters, e.g., using the CAD tool 48. The type of the part also is identified and input to step 216 along with the surface data for the part.

In step 216, the system 20 applies a plurality of geometric parameters specific to the type of the identified structural part (in the present example, a nacelle inlet) to the aerodynamic surface geometry. The parameters are applied in accordance with rules predefined for the structural type, to geometrically describe a plurality of structural features of the part. These geometric descriptions are used to identify a plurality of points representing the structure. As further described below, identification of points may be based, e.g., on geometric descriptions such as geometry measurement(s), line and surface intersection(s), ratio(s) of point(s) along line(s), one or more surface boundaries, one or more inflection points of lines and/or surfaces, and/or interface(s) of a part with other structural parts.

In step 228 the system 20 may place the identified points into one or more folders for input, e.g., in step 232 as an ASCII file to a finite element model generator. In step 232, a tool that may be separate from the system 20 is used to obtain a finite element model (FEM) from the points. One such tool is described in Powell et al., U.S. patent application Ser. No. 09/952,026, filed Sep. 12, 2001, the disclosure of which is incorporated herein by reference in its entirety. The FEM may be modeled alone or in combination with other FEMs for other structural parts. For example, a FEM for an inlet may be combined into a FEM for the nacelle that includes the inlet and modeled as part of the overall nacelle structure.

In step 236, the modeled part (e.g., inlet) is evaluated, e.g., for weight, manufacturability and/or other criteria. In step 240, it is determined whether the part could be optimized. If the part is determined to be optimal, then in step 244 the surface geometry used to obtain the optimal part and the point data representing the structure are saved. If in step 240 it is determined that the part might be further optimized, then in step 248 parameters for modifying the aerodynamic surface data may be input, e.g., via the user interface 36. In step 224 the modified parameters are used to modify the aerodynamic surface data, and the modified surface may be used in step 216 as previously described. In some implementations in which a CAD part is input in step 216, input parameters modified in step 248 may be automatically input to the CAD tool 48 to modify CAD-tool-defined surface data.

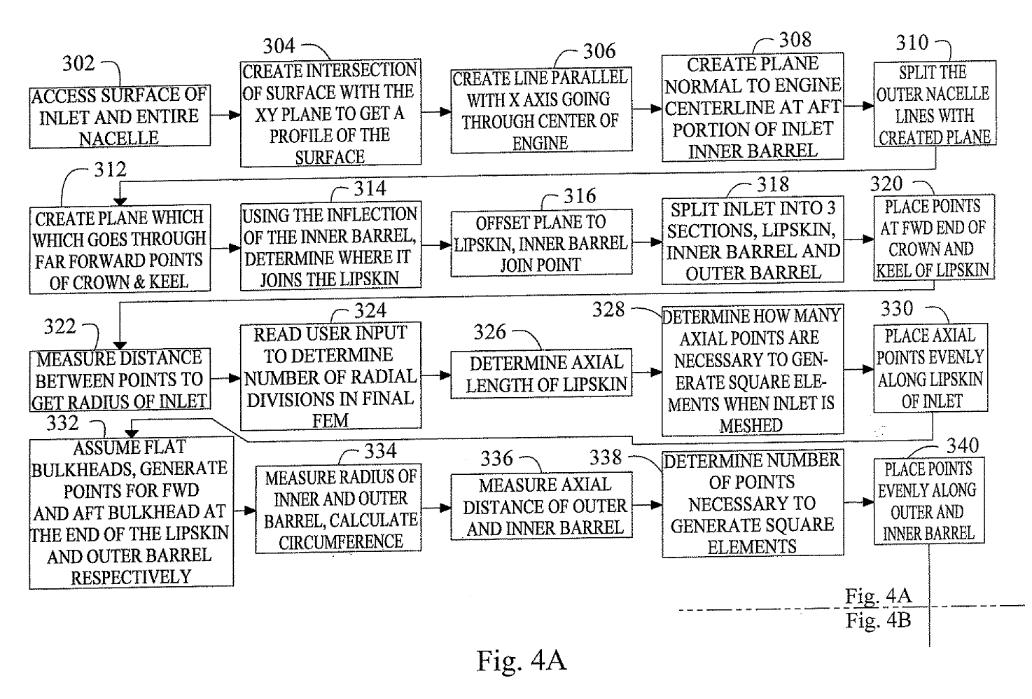

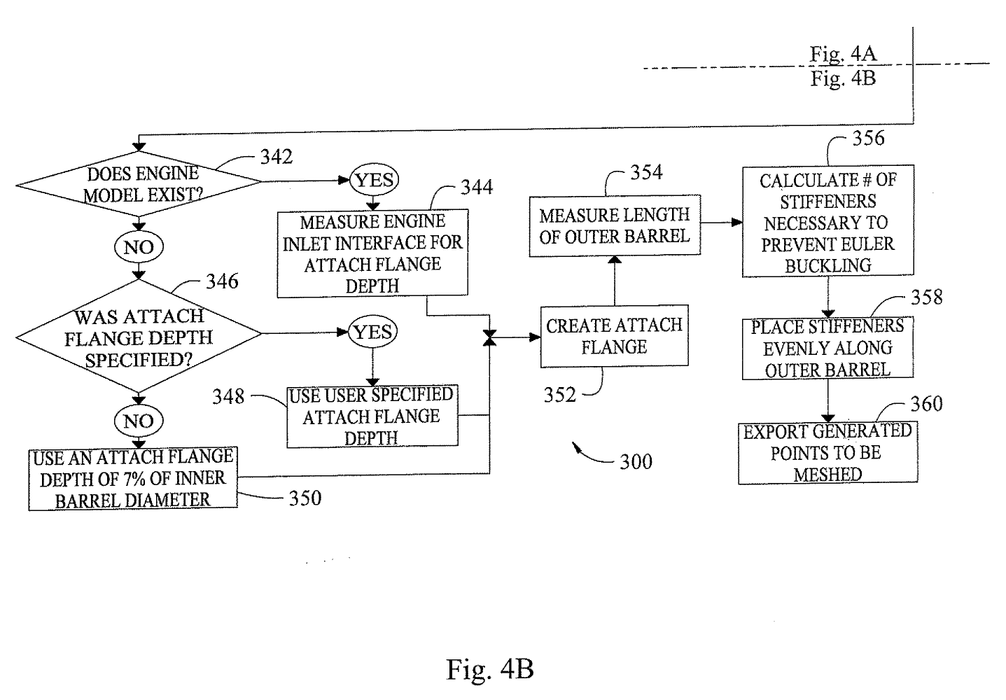

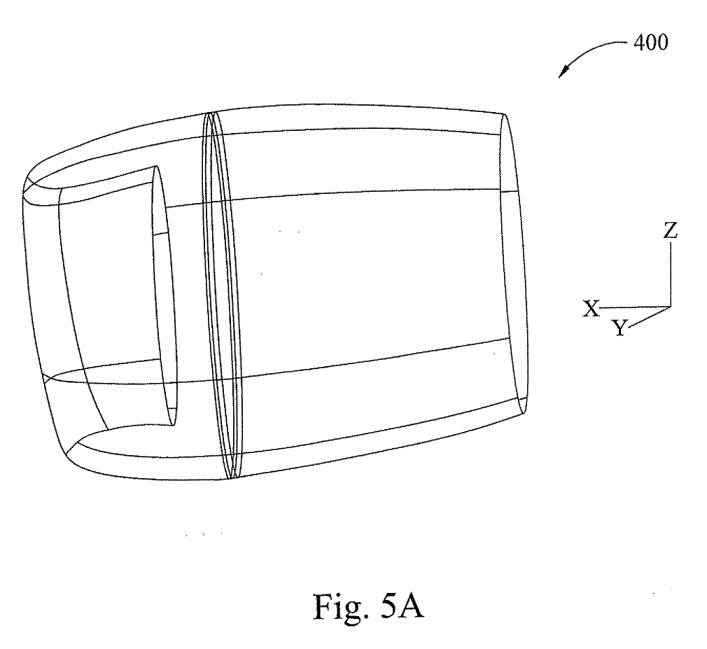

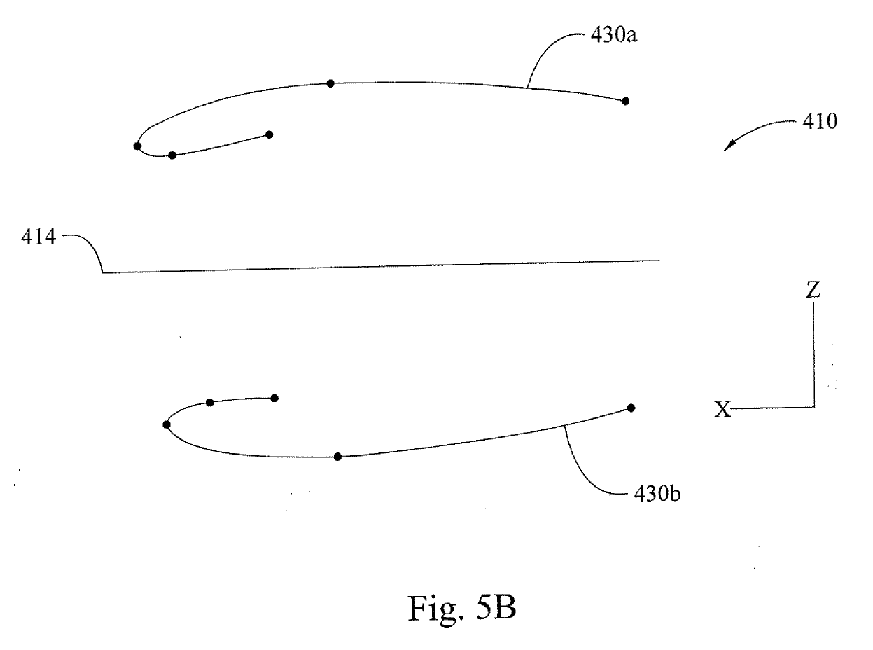

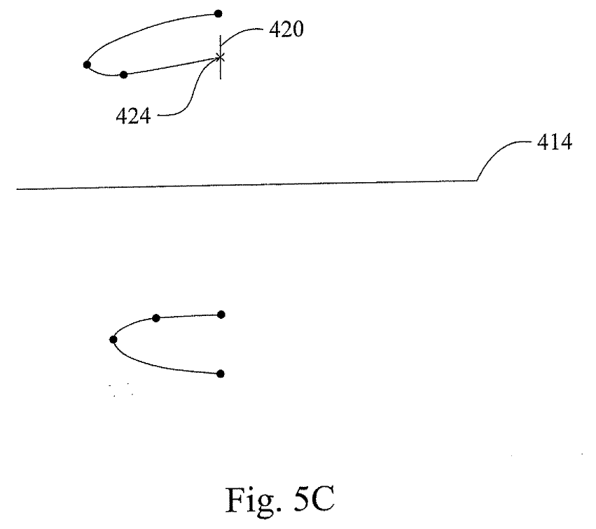

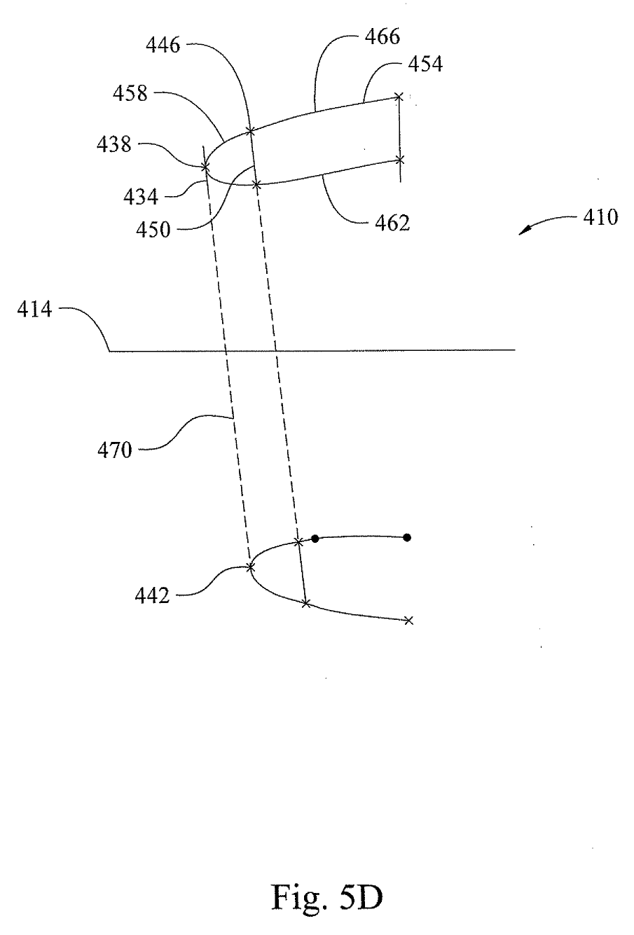

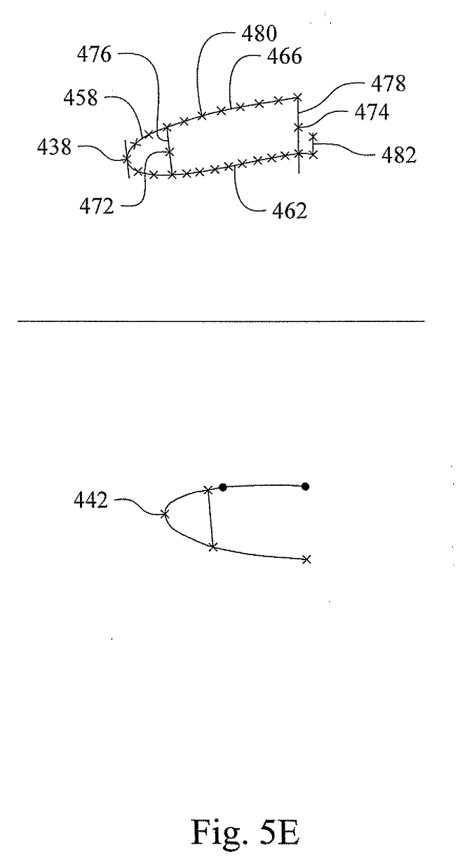

One implementation of processing that may be performed as described with reference to step 216 is described in greater detail with reference to FIG. 4. A flow diagram for generating points for a nacelle inlet is indicated generally in FIG. 4 by reference number 300. In step 302 the system 20 accesses aerodynamic surface data for an entire nacelle, including but not limited to data for an inlet. An exemplary nacelle surface is indicated generally in FIG. 5A by reference number 400. Referring again to FIG. 4, in step 304 the system 20 creates an intersection of the surface 400 with the x-z plane to obtain a profile of the surface 400. An exemplary profile is indicated generally in FIG. 5B by reference number 410. Referring to FIGS. 4 and 5B, in step 306 the system 20 creates a line 414 parallel with the x-axis that would extend through the center of an engine in the nacelle represented by the surface 400.

In step 308 the system 20 creates a plane 420, shown in FIG. 5C. The plane 420 is normal to the theoretical engine centerline 414 at a point 424, i.e., where the aft portion of the inlet inner barrel would be located. In step 310 and as shown in FIGS. 5B and 5C, the plane 420 is used to split off lines 430a and 430b indicative of the outer nacelle from the profile 410. In step 312 a plane 434 (shown in FIG. 5D) is created that extends through profile points 438 and 442 indicating where the far forward points of the inlet crown and keel respectively would be located. In step 314, an inflection point 446 of the profile 410 is used to determine where an inner barrel would join a lipskin of the inlet. In step 316 the plane 434 is offset to the inflection point 446 to provide a plane 450 indicating where the lipskin would join the inner and outer barrels. In step 318 and as shown in FIG. 5D, the profile 410 is divided into three features 454: lipskin 458, inner barrel 462, and outer barrel 466.

In step 320, the far forward points 438 and 442 are designated as input points. In step 322, a distance 470 is determined between the points 438 and 442 to obtain an inlet radius. In step 324, one or more user-defined parameters are read to determine a number of radial divisions to be included in a finite element model for the inlet. In step 326, an axial length of the lipskin 458 is determined. In step 328, the system 20 determines how many axial points would be used to generate square elements when the inlet is meshed for a FEM. In step 330 and referring to FIG. 5E, the system 20 places the determined number of axial points evenly along the lipskin 458.

In step 332 the system 20 assumes that bulkheads for the inlet are to be flat and generates input points 472 and 474 for forward and aft bulkheads 476 and 478 at the ends of the lipskin 458 and outer barrel 466 respectively. In step 334 the system 20 determines radii of the inner and outer barrels 462 and 466 respectively and calculates barrel circumferences. In step 336 the system 20 determines axial distances of the inner and outer barrels 462 and 466. In step 338 the system 20 determines numbers of points to be used to generate square elements for a FEM. Accordingly, in step 340 the system 20 places input points 480 evenly along the inner and outer barrels 462 and 466.

In step 342 the system 20 determines whether a model for the engine exists. If yes, in step 344 the system 20, referring to the engine model (not shown), determines a length of the engine inlet interface for an attach flange depth. If no engine model is used, then in step 346 it is determined whether an attach flange depth was specified, e.g., via user input. If yes, then in step 348 the system 20 uses the user-specified attach flange depth. If no, then in step 350 the system 20 uses a default attach flange depth, e.g., of 7 percent of the inner barrel 462 diameter. In step 352 the system 20 creates an attach flange 482 (shown in FIG. 5E).

In step 354 the system 20 determines a length of the outer barrel 466. In step 356 the outer barrel length is used to specify a number of stiffeners to prevent Euler buckling. In step 358 the stiffeners (not shown) are placed evenly along the outer barrel 466. In step 360, input points, including but not necessarily limited to points 438, 442, 472, 474 and 480, are exported for meshing, e.g., as previously discussed with reference to FIG. 3.

It will be appreciated that the disclosure may be implemented to obtain point input sets useful for modeling parts other than or in addition to engine nacelles. Knowledge-based rules for applying geometric parameters to surface data may be used to define structure and point sets for wings, fuselages, fins, landing gear and/or other components in the same or similar manner as previously described.

Various implementations of the disclosure can be used to eliminate the step of a person having to define structural geometry in order to create a finite element model. Cycle time between creating aerodynamic surfaces and generating a running finite element model can be greatly reduced. Additionally, the disclosure can provide a “replay ability” of finite element model generation. When a given set of surface data is used as input, the same finite element model can always be generated. This allows for a closed loop cycle where a finite element model can be iteratively used to improve aerodynamic surface definition. Additionally, the foregoing systems and methods allow for data compression: a person does not have to store surface geometry as well as a finite element model. If a user has surface geometry, he/she can generate an identical finite element model at any time, eliminating the need to store the finite element model separately.

The foregoing process is capable of distinguishing significant geometry from insignificant geometry based upon user parameters, geometrical measurements and resulting element dimension ratios, interfaces of one part with other parts, intersections and extrema within a part, and position of a point along a surface or a line. The process is capable of identifying modeling errors in CAD parts it is reading from and is capable of working around those errors at least to a limited extent.

Various implementations of the disclosure can be used to allow one person to rapidly generate many finite element models to be used in loads analysis, stress, weights, etc. Cost savings comes from the greatly increased productivity of that one person. One person can quickly do a job which would normally involve multiple people in multiple engineering disciplines.

Cost avoidance can be obtained through the early implementation of the present disclosure. The ability to use finite element models early in the design process can help improve designs early in the design process. Previously, finite element models were implemented only after a fairly stable configuration had been determined.

Implementations of the foregoing methods and systems would allow a person who is not familiar with one type of part to generate a finite element model of that part. The rapidly produced FEM could then be used to aid in the analysis of that part and/or another part. Various implementations of the disclosure can be used to decrease what has typically been a long turnaround time between creation of aerodynamic surfaces of a part and creation of finite element models. Defining a structure by hand can be time consuming and frustrating. Furthermore, structural geometry must be redefined every time the aerodynamic surfaces change. Various implementations of the disclosure can be used to define structural geometry from surface geometry and can greatly increase the speed at which a finite element model can be created.

What is claimed is:

1. A computer-performed method of modeling a physical structure, the method comprising:
applying a plurality of geometric parameters specific to a type of the structure to aerodynamic surface data in accordance with rules predefined for the structure type to geometrically describe a plurality of structural features;
based on the geometric describing, obtaining a plurality of points representing the structure; and
using the points to model the structure.

2. The method of claim 1, further comprising using the points to obtain a finite element model of the structure.

3. The method of claim 1, wherein applying geometric parameters to the surface data comprises using one or more of the following: a geometric dimension, an intersection, an edge, an extremum, an inflection point, a dimension ratio, a position of a point, and an interface between parts in and/or related to the structure.

4. The method of claim 1, further comprising obtaining the aerodynamic surface data via a computer-assisted drawing tool.

5. The method of claim 1, wherein the aerodynamic surface data includes surface data for a part that includes the structure, and applying the geometric parameters comprises splitting off a portion of the aerodynamic surface data relating to the part.

6. The method of claim 1, further comprising modifying the aerodynamic surface data based on input from a user.

7. The method of claim 6, the modifying performed via a computer-assisted drawing tool used to obtain the aerodynamic surface data.

8. A system for automatically generating a point representation of a structure, the system comprising a processor and memory configured to:
apply, in accordance with rules predefined for a type of the structure, a plurality of geometric parameters to an aerodynamic surface defined for the structure;
use one or more results of the applying to geometrically describe a plurality of structural features; and
use the features to define a plurality of points representing the structure.

9. The system of claim 8, processor and memory further configured to use the plurality of points to obtain a finite element model of the structure.

10. The system of claim 8, the processor and memory further configured to obtain the surface definition for the structure via a computer-assisted drawing tool.

11. The system of claim 8, the processor and memory further configured to use at least one of an inflection point and an extremum of the surface definition to describe one or more of the structural features.

12. The system of claim 8, the processor and memory further configured to:
use an intersection of a plane with the surface definition to obtain a profile of the structure; and
use the profile to geometrically describe one or more of the structural features.

13. The system of claim 12, wherein the structure type is an inlet of an aircraft engine nacelle, and the one or more features include at least one of the following: a lipskin, an inner barrel, an outer barrel, and bulkhead.

14. The system of claim 8, the processor and memory further configured to:
determine a length of one of the features; and
based on the determined length, determine a number of points representing the feature in the plurality of points representing the structure.

15. A computer-readable medium for automatically generating a point representation of a physical structure, the medium comprising instructions executable by a computer for:
using a surface definition of the structure to obtain parameters geometrically descriptive of at least part of the structure;
using the parameters to define at least some features of the structure; and
based on the at least some features, defining a plurality of points representing the structure.

16. The computer-readable medium of claim 15, further comprising instructions executable by a computer for:
defining a plurality of sets of points, each set representing a different structure; and
combining the sets to obtain a model representing a combination of the different structures.

17. The computer-readable medium of claim 16, wherein the model includes a finite element model.

18. The computer-readable medium of claim 15, further comprising instructions executable by a computer for using the points to obtain a finite element model.

19. The computer-readable medium of claim 15, wherein the structure includes one or more parts of one or more of the following: an aircraft engine nacelle, an aircraft wing, an aircraft fuselage, and an aircraft landing gear.

20. The computer-readable medium of claim 15, further comprising instructions executable by a computer for modifying, based on user input, at least one of the surface definition of the structure and the geometrically descriptive parameters.
